(19) United States
(12) Patent Application Publication
(10) Pub. No.: US 2025/0020953 A1
(43) Pub. Date: Jan. 16, 2025

(54) POLARIZER AND LIQUID CRYSTAL DISPLAY DEVICE

(71) Applicant: TCL CHINA STAR OPTOELECTRONICS TECHNOLOGY CO., LTD., ShenZhen, Guangdong (CN)

(72) Inventors: Ji LI, ShenZhen, Guangdong (CN); Guang ZENG, ShenZhen, Guangdong (CN); Hanming LI, ShenZhen, Guangdong (CN); Hongshan YIN, ShenZhen, Guangdong (CN); Fang TAN, ShenZhen, Guangdong (CN); Kai CHEN, ShenZhen, Guangdong (CN)

(73) Assignee: TCL CHINA STAR OPTOELECTRONICS TECHNOLOGY CO., LTD., ShenZhen, Guangdong (CN)

(21) Appl. No.: 18/279,402

(22) PCT Filed: Aug. 10, 2023
(86) PCT No.: PCT/CN2023/112216

§ 371 Date: Aug. 30, 2023

(30) Foreign Application Priority Data
Apr. 13, 2023 (CN) 202310394671.X

(51) Int. Cl. G02F 1/1335

(52) U.S. Cl. CPC G02F 1/133507; G02F 1/133528; G02F 2201/50

(57) ABSTRACT

A polarizer and a liquid crystal display device are disclosed. The polarizer includes a first protection film, a polarization layer, a second protection film, a chroma viewing angle enhancement layer, and a surface protection film laminated. Material of the chroma viewing angle enhancement layer includes a resin composite. The resin composite includes a light diffusion agent. The light diffusion agent is aligned in the chroma viewing angle enhancement layer, an acute angle is defined between a long axis direction of light diffusion agent and a bottom surface of the chroma viewing angle enhancement layer, and the acute angle is greater than 0° and is less than or equal to 40°.

The present application claims a priority of a Chinese patent application No. 202310394671.X, titled “POLARIZER AND LIQUID CRYSTAL DISPLAY DEVICE”, filed with the China National Intellectual Property Administration (CNIPA) on Apr. 13, 2023, in which all contents of the aforementioned application are incorporated in the present application by reference.

### FIELD OF INVENTION

The present application relates to a field of display technologies, especially to a polarizer and a liquid crystal display device.

### BACKGROUND OF INVENTION

Due to its advantages of low energy consumption, large visible area, and high resolution, the liquid crystal display (LCD) device finds widespread applications in various electronic product fields, including television, computers, cell phones, tablets, and automotive display devices. However, when compared to other self-emissive display devices, the chroma viewing angle of the liquid crystal display device is relatively poorer. This is particularly noticeable in the case of liquid crystal display devices operating in VA (Vertical Alignment) mode, where significant color deviation occurs when viewed from side angles. To address this issue, conventional techniques involve affixing a layer of viewing angle expansion film onto the upper polarizer of the liquid crystal display device. While this viewing angle expansion film does significantly enhance the chroma viewing angle of the liquid crystal display device, it comes with a significant trade-off that substantially reduces the frontal brightness of the device, thereby decreasing its contrast ratio.

Consequently, there is a need for improvement in conventional liquid crystal display devices to enhance their chroma viewing angle.

### SUMMARY OF INVENTION

The present application provides a polarizer and a liquid crystal display device, to solve a technical issue that a chroma viewing angle of a conventional liquid crystal display device needs improvement.

The present application provides a polarizer, comprising:
a polarization layer;
a first protection film located on a side of the polarization layer;
a second protection film located on an opposite side of the polarization layer; and
a surface protection film located on a side of the second protection film away from the polarization layer, wherein
a chroma viewing angle enhancement layer is disposed between the second protection film and the surface protection film, material of the chroma viewing angle enhancement layer comprises a resin composite, the resin composite comprises a light diffusion agent, the light diffusion agent is aligned in the chroma viewing angle enhancement layer, an acute angle is formed between a long axis direction of the light diffusion agent and bottom surface of the chroma viewing angle enhancement layer, and the acute angle is greater than 0° and is less than or equal to 40°.

In some embodiments of the present application, the light diffusion agent comprises whiskers and a modified group connected to surfaces of the whiskers, a structure formula of the modified group is —X-A-R, wherein X is selected from SO3 or PO4H, A is selected from a substituted or unsubstituted aromatic group in form of a single bond with a number of ring atoms ranging from 6 to 20, or imidazoline group, R is selected from a substituted or unsubstituted alkyl group with a number of carbon atoms of 2-20, a substituted or unsubstituted siloxane group with a number of carbon atoms ranging from 2 to 20, or alkyl alcohol with a number of carbon atoms ranging from 2 to 20 amide group.

In some embodiments of the present application, a structural general formula of R is

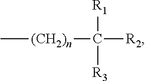

R1, R2, R3 are individually selected from F, Cl, Br, i or H, n is an integer ranging from 1 to 19.

In some embodiments of the present application, R1, R2, R3 are individually selected from F or H, and at least one of R1, R2, R3 is selected from F; and/or X is selected from SO3; and/or A is selected from a substituted or unsubstituted aromatic group with a number of ring atoms ranging from 6 to 20.

In some embodiments of the present application, the modified group is selected from at least one of structure formulas as follows:

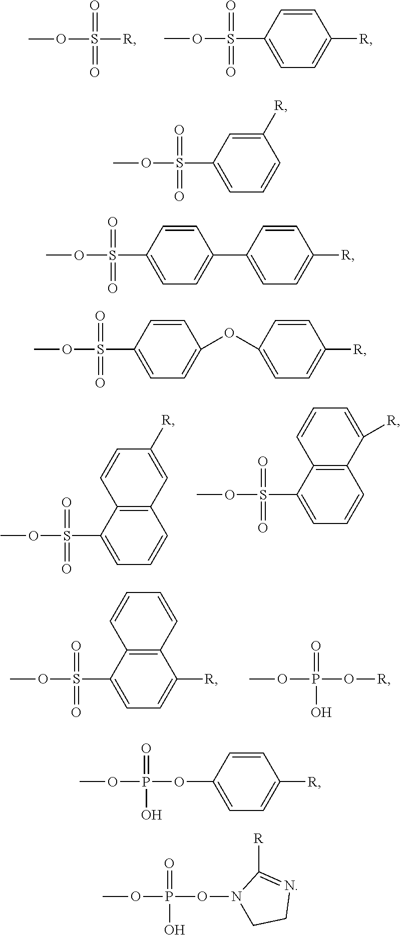

In some embodiments of the present application, a film thickness of the chroma viewing angle enhancement layer ranges from 5 to 100 microns.

In some embodiments of the present application, an orthographic projection of a long axis of the light diffusion agent in a first plane has a first orientation angle, an orthographic projection of an absorption axis of the polarization layer in the first plane has a second orientation angle, and an average of a difference between the first orientation angle and the second orientation angle is less than or equal to 5°, and the first plane is parallel to a plane in which the polarization layer is located.

In some embodiments of the present application, a film thickness of the chroma viewing angle enhancement layer ranges from 5 to 100 microns.

In some embodiments of the present application, according to a total mass of the resin composite, the resin composite comprises: acrylate copolymer with a mass percentage ranging from 20% to 80%; coupling agent with a mass percentage ranging from 0.1% to 10%; crosslinking agent with a mass percentage ranging from 0.1% to 20%; and the light diffusion agent with a mass percentage ranging from 0.1% to 50%.

In some embodiments of the present application, an adhesive layer is disposed between the second protection film and the surface protection film; the chroma viewing angle enhancement layer is reused as the adhesive layer, or the chroma viewing angle enhancement layer is disposed between the adhesive layer and the surface protection film.

The present application also provides a liquid crystal display device, comprising a liquid crystal display panel and the polarizer of any one of the above embodiments located on a light exiting side of the liquid crystal display panel.

Advantages of the present application: a chroma viewing angle enhancement layer is integrated in a polarizer. Light diffusion agent aligned in the chroma viewing angle enhancement layer can diffuse light toward two sides to expand a chroma viewing angle of the liquid crystal display device. Also, the chroma viewing angle enhancement layer including the light diffusion agent would not negatively influence brightness of the right viewing angle of the liquid crystal display device.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may also acquire other figures according to the appended figures without any creative effort.

FIG. 1 is a first schematic structural view of a polarizer provided by an embodiment of the present application.

FIG. 2 is a schematic view of an arrangement angle of a light diffusion agent of a chroma viewing angle enhancement layer provided by the embodiment of the present application.

FIG. 3 is a second schematic structural view of the polarizer provided by the embodiment of the present application.

FIG. 4 is a first schematic structural view of a liquid crystal display device provided by the embodiment of the present application.

FIG. 5 is a second schematic structural view of the liquid crystal display device provided by the embodiment of the present application.

FIG. 6 is a schematic view of a modification mechanism of a modifier agent of alkyl cyclic acids provided by the embodiment of the present application.

FIG. 7 is a first schematic view of a modified group of a surface of the whisker provided by the embodiment of the present application.

FIG. 8 is a second schematic structural view of the modified group of the surface of the whisker provided by the embodiment of the present application.

FIG. 9 is a schematic view of a modification mechanism of a modifier agent of alkyl phosphate esters provided by the embodiment of the present application.

### DETAILED DESCRIPTION OF PREFERRED EMBODIMENTS

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all another embodiments obtained by those skilled in the art without making any creative effort shall fall within the protection scope of the present application.

In the description of the present application, it is important to understand that terms such as “thickness,” “upper,” “lower,” “vertical,” “horizontal,” “top,” “bottom,” “inner,” “outer,” and similar directional or positional indications are based on the orientations or positional relationships as depicted in the accompanying drawings. These indications are used solely for the purpose of facilitating the description and simplifying the presentation of the present application, rather than indicating or implying that the devices or elements referred to must possess specific orientations, be constructed and operated in particular orientations. Therefore, they should not be construed as limitations on the present application. In the present application, unless explicitly specified and limited otherwise, the term “on” or “under” in relation to a first feature with respect to a second feature encompasses both direct contact between the first and second features, as well as contact between them through other intervening features.

The present application provides a resin composite, according to a total mass of the resin composite, the resin composite comprises: acrylate copolymer with a mass percentage ranging from 20% to 80%, coupling agent with a mass percentage ranging from 0.1% to 10%, crosslinking agent with a mass percentage ranging from 0.1% to 20%, and the light diffusion agent with a mass percentage ranging from 0.1% to 50%. The resin composite can be applied to the chroma viewing angle enhancement layer of the liquid crystal display device. The light diffusion agent aligned in the chroma viewing angle enhancement layer can diffuse light to expand light towards sides to expand the chroma viewing angle of the liquid crystal display device. Also, the chroma viewing angle enhancement layer having the light diffusion agent would not cause negative influence to brightness of the right viewing angle of the liquid crystal display device.

In particular, material of the light diffusion agent comprises whiskers and a modified group connected to surfaces of the whiskers.

A structure formula of the modified group is —X-A-R. X is selected from SO₃ or PO₄H, A is selected from a single bond, a substituted or unsubstituted aromatic group with a number of carbon atoms ranging from 6 to 20, or an imidazoline group, R is selected from a substituted or unsubstituted alkyl group with a number of carbon atoms ranging from 2 to 20, a substituted or unsubstituted siloxane group with a number of carbon atoms ranging from 2 to 20, or alkyl alcohol with a number of carbon atoms ranging from 2 to 20 amide group. Unless otherwise specified, in the embodiments of the present application, the term “substituted or unsubstituted” as mentioned refers to the hydrogen on a carbon atom being replaced by F, Cl, Br, or I, or remaining unsubstituted.

Modifying the whiskers through the above modified group, in an aspect, not only can improve dispersion of the whiskers in the resin, in another aspect, but also a surface of the whisker particle formed with a sulfonic acid group shell layer or a phosphate group shell layer can protect the whisker particles and enhance toughness of the whisker particles to prevent broken whiskers. Furthermore, because a modified surface of the whisker is connected to an organic layer, growth along a radial direction (short diametric direction) of the whisker is restrained and a longitudinal direction (long diametric direction) of the whisker is unchanged, a length-diameter ratio of the whisker is further improved, which further lowers a probability of fracture of the whiskers during agitation, and improves capabilities of the chroma viewing angle enhancement of the chroma viewing angle enhancement layer.

In some embodiments, R group can be a substituted or unsubstituted alkyl chain and can restrain growth of whisker particles along a radial direction and improve a length-diameter ratio of the whiskers.

In particular, a structural general formula of R is

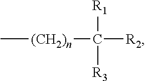

wherein R₁, R₂, R₃ are individually selected from F, Cl, Br, i or H, n is an integer ranging from 1 to 19. Modifying a distal end of a long chain with a halogen atom can enhance stability of the whisker.

Optionally, a value of n can be 2, 3, 4, 5, 6, 7, 8, 9, 10, 11, 12, 13, 14, 15, 16, 17, or 18.

In some embodiments, R₁, R₂, R₃ are individually selected from F or H, and at least one of R₁, R₂, R₃ is selected from F. In an aspect, the F—C bond energy is high and is difficult to break. In another aspect, the F atom has a shielding effect to the C—C bond.

Furthermore, R₁, R₂, R₃ are all selected from F. Namely, a distal end group of R is perfluorinated. A radius of a F atom is greater than a radius of a hydrogen atom and can effectively shield and protect a perfluorinated C—C bond and reduce a probability of a damaged C—C bond. Also, while protecting the C—C bond, the radius of the F atom is not great enough to cause a three-dimensional tension in the perfluorocarbon chain, therefore the fluorocarbon chain is more stable.

In some embodiments, optionally, A is selected from a substituted or unsubstituted aromatic group with a number of ring atoms ranging from 6 to 20, for example, phenyl group, diphenyl group, or naphthyl group. A steric hindrance of the benzene ring is greater, the surface of the whisker has an organic protective layer containing a benzene ring, during mixing and agitating of the light diffusion agent and the resin, such organic protective layer can buffer a mutual force to prevent broken whiskers during agitation.

Optionally, X is a sulfonic acid group. During agitation, a sulfonic acid group shell layer formed on the surface of the whisker can protect the whisker, prevents the broken whisker, which achieves an effect of enhancing toughness of the whisker.

The modified group is selected from at least one of structure formulas as follows:

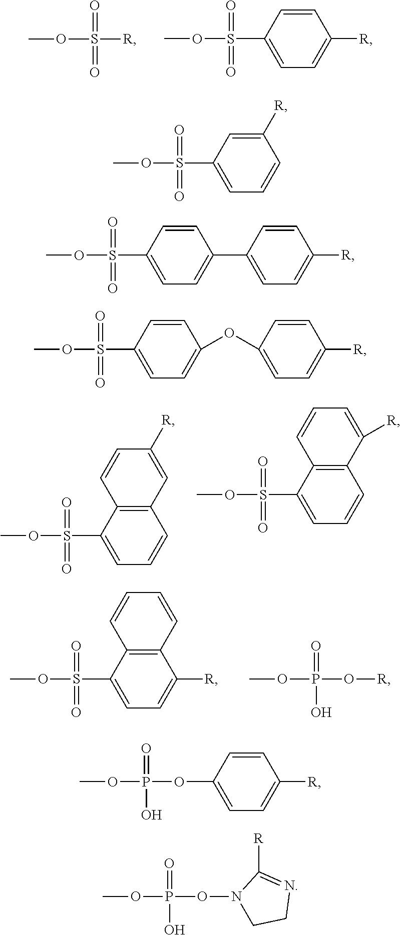

Furthermore, the modified group is selected from at least one of structure formulas as follows:

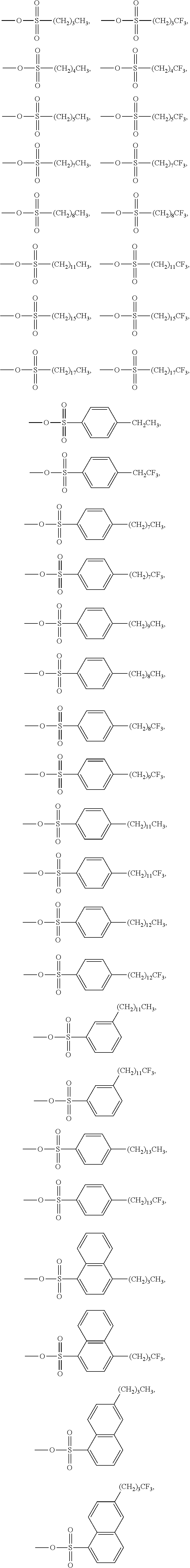

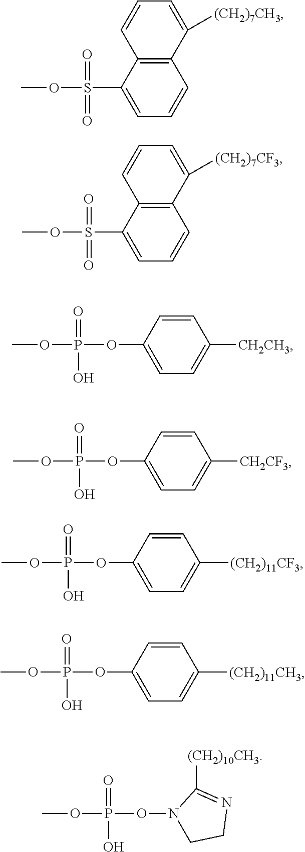

The modified group mentioned above is for illustration purposes only. The modified group in the present embodiment is not limited to this. A modifier agent that modifies the whiskers can correspondingly be selected from the modifier agents associated with the modified group listed above. The modifier agent can be at least one of alkyl sulfonates, fluoroalkyl sulfonates, aromatic alkyl phosphates, fluoroaromatic alkyl phosphates, alkyl phosphates, alkyl phosphate salts, aromatic alkyl phosphates, aromatic alkyl phosphate salts, alkyl acyl ammonium phosphates, alkyl acyl ammonium phosphate salts, imidazolinyl phosphates, imidazolinyl phosphate salts, siloxane phosphates, polyphosphates, and polyphosphate salts.

In particular, the modifier agent can be at least one of sodium dodecyl sulfate, perfluoro-1-dodecyl sulfate, sodium 4-dodecylbenzenesulfonate, sodium 3-dodecylbenzenesulfonate, sodium 1-docosanesulfonate, perfluoro-1-docosanesulfonate, sodium 1-butanesulfonate, perfluoro-1-butanesulfonate, sodium 1-octanesulfonate, perfluoro-1-octanesulfonate, sodium nonanesulfonate, perfluoro-1-nonanesulfonate, sodium pentanesulfonate, perfluoro-1-pentanesulfonate, sodium 1-heptanesulfonate, perfluoro-1-1-heptanesulfonate, perfluoro-1-hexadecanesulfonate, perfluoro-1-hexadecanesulfonate, perfluoro-1-octadecanesulfonate, sodium 4-ethylbenzenesulfonate, sodium docosylbenzenesulfonate, sodium para-ethylbenzenesulfonate, sodium 4-octylbenzenesulfonate, sodium butylnaphthalenesulfonate.

Furthermore, the whiskers include at least one of carbon fiber whiskers, magnesium carbonate whiskers, zinc oxide whiskers, magnesium borate whiskers, aluminum borate whiskers, calcium carbonate whiskers, calcium sulfate whiskers, potassium titanium whiskers, silicon carbide whiskers, and magnesium sulfate whiskers.

A method for modifying the light diffusion agent comprises: a step S10 dispersing whiskers in a dispersion liquid to form a whisker suspension; a step S20, adding the modifier agent in the whisker suspension and simultaneously agitating the whisker suspension to modify the whiskers to obtain a mixture; and a step S30 purifying the mixture to obtain a light diffusion agent.

The dispersion liquid can be a mild alkaline or alkaline solvent, and the dispersion liquid comprises at least one of sodium hydroxide, deionized water, methanol, ethylene glycol, propylene glycol, n-butanol, isobutanol, aqueous ammonia.

In the step S10, a mass percentage of the whiskers in the suspension ranges from 5% to 20%, and specifically can be 5%, 6%, 7%, 8%, 9%, 10%, 12%, 13%, 15%, 16%, 17%, 18%, 19%, or 20%. A mass ratio of the modifier agent to the dispersion liquid can be 0.5:1-1:1, and specifically can be 0.5:1, 0.8:1, 0.9:1 or 1:1.

In the steps S10 and S20, a temperature of a system is controlled to range from 65° C. to 75° C., specifically can be 65° C., 68° C., 70° C., 72° C., or 75° C. In the step S20, an agitation rate can range from 700 r/min to 900 r/min, and specifically can be 700 r/min, 720 r/min, 740 r/min, 750 r/min, 760 r/min, 780 r/min, 800 r/min, 810 r/min, 820 r/min, 850 r/min, 860 r/min, 880 r/min, or 900 r/min, and a modification time (responsive time) can range from 40 min to 80 min, and specifically can be 40 min, 50 min, 55 min, 60 min, 65 min, 70 min, or 80 min.

The purification step comprises: sequentially implementing filtration, water washing, filtration, alcohol washing, vacuum drying, and grinding to the mixture to obtain a modified light diffusion agent.

In the above modifying method, by agitation, the modifier agent fully contact the whiskers in the dispersion liquid for modification. During such process, —OH in the dispersion liquid partially dissolves and exposes atoms on the surface of the whisker, at this time, a mutual force is formed between the functional group in the modifier agent and the atoms exposed on the surface to make the modifier agent attached to the surface of the whisker. By adjusting the temperature of the system, concentration of the modifier agent, and agitation rate, mutual force is adjusted to adjust the shape of the whiskers.

In particular, calcium carbonate whiskers modified by a modifier agent of alkyl benzene sulfonic acids and a modifier agent of alkyl phosphate esters is used as an example for explanation.

A modification mechanism of the modifier agent of alkyl benzene sulfonic acids is as shown in FIG. 6. Compared to a general modifier agent, the modifier agent of alkyl benzene sulfonic acids, in an aspect, can effectively enhance of toughness of the calcium carbonate whiskers. During agitation, a benzene ring sulfonic acid group shell layer is formed on the surface of the whisker and can protect the calcium carbonate whiskers and prevent the whiskers from fracture to achieve a toughness improvement effect. In another aspect, because a surface of the calcium carbonate whisker has an organic layer, growth of calcium carbonate whiskers along a radial direction is restrained and growth along a longitudinal direction is not influenced, a length-diameter ratio of the calcium carbonate whiskers would be increased to prevent the calcium carbonate whiskers from fracture during agitation. Also, the long chain can also enhance a dispersion capability of the calcium carbonate whiskers in the resin.

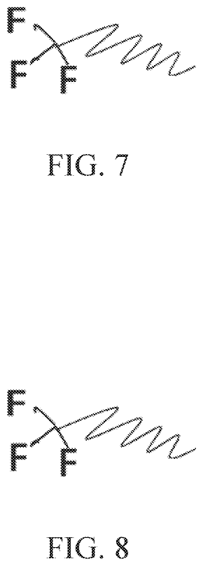

Furthermore, when H on an end group of the modifier agent of alkyl sulfonic acids or the modifier agent of alkyl benzene sulfonic acids is fully substituted by F atoms, which can enhances stability of calcium carbonate whiskers. A modified group of the surface of the calcium carbonate whisker is as shown in FIGS. 7 and 8. In an aspect, a F—C bond energy is high and is difficult to break. In another aspect, the F atom has a shielding effect to the C—C bond and can reduce probability of breaking the C—C bond.

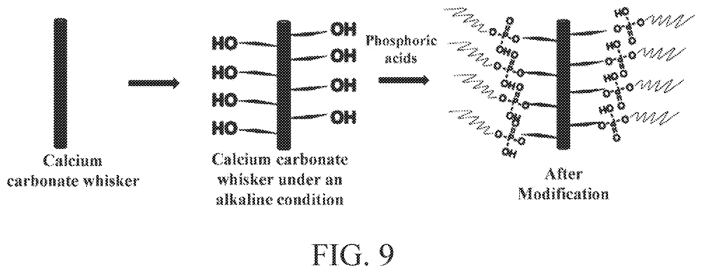

A modification mechanism of the modifier agent of alkyl phosphate esters is similar to a modification mechanism of the modifier agent of alkylsulfonic acids, and the modification mechanism is as shown in FIG. 9.

The acrylic copolymer comprises first monomers and second monomers. The first monomers comprise methyl methacrylate. The second monomer comprises at least one of methyl methacrylate, ethyl acrylate, ethyl methacrylate, isopropyl methacrylate, isobutyl methacrylate, tert-butyl methacrylate, butyl methacrylate, hydroxyethyl methacrylate, cyclohexyl methacrylate, cyclohexyl methacrylate, isopropyl acrylate, butyl acrylate, tert-butyl acrylate, cyclohexyl acrylate, cyclohexyl acrylate, hydroxyethyl acrylate, acrylic acid, methyl acrylate, acrylamide, n-octyl acrylate, dodecyl acrylate, n-hexyl acrylate, isooctyl acrylate, hexadecyl acrylate.

Compared to a total mass of the acrylic copolymer, a mass percentage of the first monomer ranges from 50% to 95%, a mass percentage of the second monomer ranges from 5% to 50%.

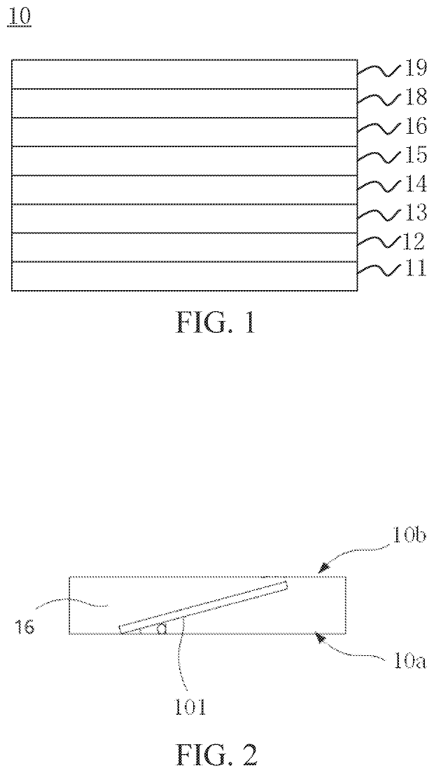

With reference to FIG. 1, FIG. 1 is a first schematic structural view of a polarizer provided by an embodiment of the present application.

The present embodiment provides a polarizer 10 comprising a polarization layer 14, a first protection film 13 located on a side of the polarization layer 14, a second protection film 15 located on an opposite side of the polarization layer 14, and a surface protection film 19 located on a side of the second protection film 15 away from the polarization layer 14. A chroma viewing angle enhancement layer 16 is further disposed between the second protection film and the surface protection film. Material of the chroma viewing angle enhancement layer 16 comprises a resin composite, and the resin composite comprises a light diffusion agent. The light diffusion agent is aligned in the chroma viewing angle enhancement layer. The light diffusion agent aligned can diffuse light to diffuse light toward two sides to expand the chroma viewing angle of the liquid crystal display device.

The polarization layer 14 can be a polyvinyl alcohol (PVA) film layer. The first protection film 13 and the second protection film 15 comprise but are not limited to one of triacetate (TAC) film, polyethylene terephthalate (PET) film, PMMA film, COP film, and PC film.

The surface protection film 19 comprises but is not limited to one of PET thin film, polyethylene (PE) thin film, polypropylene thin film, PMMA thin film (poly(methyl methacrylate) thin film), TAC thin film, and PC thin film (polycarbonate thin film).

The polarization layer 14 performs a polarization function. The first protection film 13 and the second protection film 15 performs a protection function for the polarization layer 14 to prevent water oxygen from entering the polarization layer 14. The surface protection film 19 is configured to protect the polarizer 10 and prevent the polarizer 10 from suffering break during storage or transport.

The chroma viewing angle enhancement layer 16 is configured to expand a chroma viewing angle of the liquid crystal display device. Material of the chroma viewing angle enhancement layer 16 comprises a resin composite. The resin composite comprises acrylic copolymer and a light diffusion agent aligned. The light diffusion agent can diffuse light to expand light towards sides to expand the chroma viewing angle of the liquid crystal display device.

With reference to FIG. 2, an acute angle α is formed between the long axis direction of the whiskers 101 of the chroma viewing angle enhancement layer 16 and a bottom surface 10a of the chroma viewing angle enhancement layer 16. When the acute angle α greater than or is equal to 0° and is less than or equal to 40°, it advantages improvement of contrast, brightness viewing angle, and chroma viewing angle. In particular, this might be due to the fixed length of whiskers, resulting in a constant amount of light scattering by the whiskers. The light scattering by the whiskers can be divided into components along the direction parallel to the bottom surface of the resin layer (referred to as the horizontal component) and components along the direction perpendicular to the bottom surface of the resin layer (referred to as the vertical component). If the horizontal component is larger, the vertical component is smaller. When the angle between the whiskers and the resin layer decreases, the horizontal component becomes larger (meaning that the projection of the whiskers on the resin layer is greater). As a result, the lateral scattering becomes stronger, leading to better lateral viewing angle performance. Conversely, the opposite is true.

The chroma viewing angle enhancement layer 16 comprises a bottom surface 10a and a top surface 10b opposite to each other along a direction of lamination of film layers. Optionally, the bottom surface 10a is located on a light incident side (namely, a side of the display panel emitting light) of a top surface 10b. Alternatively, the bottom surface 10a is a surface formed first during formation of the chroma viewing angle enhancement layer 16. With reference to FIG. 2, it can be understood that with respect to a normal (which is in the thickness direction of the chroma viewing angle enhancement layer 16), the arrangement angle (referred to as acute angle a) of the whiskers can tilt to the left side of the normal or to the right side of the normal.

Furthermore, experimental results indicates that when an acute angle between the long axis direction of the whiskers 101 and a bottom surface of the chroma viewing angle enhancement layer 16 is less than or equal to 20°, the contrast, brightness viewing angle, chroma viewing angle would be improved further. In particular, an angle between the long axis direction of the whisker and the bottom surface 10a of the chroma viewing angle enhancement layer 16 is zero. Namely, an alignment direction of the whiskers 101 is parallel to the bottom surface 10a of the chroma viewing angle enhancement layer 16. Furthermore, a long axis direction of the chroma viewing angle enhancement layer 16 can be the same as the absorption axis direction of the polarizer.

A conventional technology bonds a viewing angle expansion film directly on the upper polarizer 10 of the liquid crystal display device. However, such solution would drastically lower a right viewing angle brightness of the liquid crystal display device while expanding the chroma viewing angle to further reduce contrast of the liquid crystal display device. Compared to the conventional technology, the above solution provided by the present application not only improves contrast of the liquid crystal display device but also has no negative effect to brightness of the right viewing angle.

In the embodiment of the present application, the whiskers 101 include but are not limited to at least one of carbon fiber whiskers, magnesium carbonate whiskers, zinc oxide whiskers, magnesium borate whiskers, aluminum borate whiskers, calcium carbonate whiskers, calcium sulfate whiskers, potassium titanium whiskers, silicon carbide whiskers, and magnesium sulfate whiskers.

Compared to the total mass of the resin composite, a mass percentage of the light diffusion agent ranges from 0.1% to 50%, and specifically can be 0.1%, 10%, 20%, 30%, 40%, or 50%. An added amount of the inorganic whiskers within such range can effectively improve the chroma viewing angle of the liquid crystal display device.

In the embodiment of the present application, a film thickness of the chroma viewing angle enhancement layer 16 ranges from 5 to 100 microns. In particular, tu film thickness can be 5 microns, 10 microns, 30 microns, 50 microns, 60microns, 80 microns, or 100 microns.

Compared to the total mass of the resin composite, a mass percentage of the acrylic copolymer ranges from 20% to 80%, and specifically can be 20%, 50%, 60%, 70%, or 80%.

In some embodiments of the present application, the acrylic copolymer comprises a first monomer and a second monomer. The first monomer comprises methyl methacrylate. The second monomer comprises at least one of methyl methacrylate, ethyl acrylate, ethyl methacrylate, isopropyl methacrylate, isobutyl methacrylate, tert-butyl methacrylate, butyl methacrylate, hydroxyethyl methacrylate, cyclohexyl methacrylate, cyclohexyl methacrylate, isopropyl acrylate, butyl acrylate, tert-butyl acrylate, cyclohexyl acrylate, cyclohexyl acrylate, hydroxyethyl acrylate, acrylic acid, methyl acrylate, acrylamide, n-octyl acrylate, dodecyl acrylate, n-hexyl acrylate, isooctyl acrylate, and hexadecyl acrylate.

Compared to a total mass of the acrylic copolymer, a mass percentage of the first monomer ranges from 50% to 95%, and a mass percentage of the second monomer ranges from 5% to 50%.

Furthermore, the resin composite further comprises a coupling agent, and the coupling agent can improve adhesion of the resin composite. Compared to the total mass of the resin composite, a mass percentage of the coupling agent ranges from 0.1% to 10%.

The coupling agent comprises but is not limited to at least one of vinyltriethoxysilane, vinyltrimethoxysilane, and aminopropyltriethoxysilane, glycidoxypropyltrimethoxysilane.

Furthermore, the resin composite further comprises a crosslinking agent, the crosslinking agent causes crosslink of the resin in a certain extent to prevent overfast aging. A mass percentage of the crosslinking agent ranges from 0.1% to 20%.

The crosslinking agent comprises but is not limited to at least one of toluene diisocyanate, isophorone diisocyanate, xylene diisocyanate, glycerol tris(3-isocyanatopropyl) ether, ethylene glycol diglycidyl ether, and glycerol diglycidyl ether.

The resin composite can be applied to the substrate through methods such as slot coating, blade coating, or curtain coating. The curing of the resin composite can be accomplished through heat curing or light curing.

During the application process, the use of shear forces from the coating can align the light diffusion agent within the film layer.

In some embodiments, an adhesive layer (not shown in the figures) is disposed between the second protection film 15 and the surface protection film 19 [symbol] , the chroma viewing angle enhancement layer 16 can be disposed between the adhesive layer and the surface protection film, and the chroma viewing angle enhancement layer 16 is connected to the polarization layer 14 through the adhesive layer. The adhesive layer can be a transparent pressure sensitive adhesive layer. In another embodiment, the chroma viewing angle enhancement layer 16 can be reused as the adhesive layer. When the chroma viewing angle enhancement layer 16 is reused as the adhesive layer, acrylate copolymer in the resin composite should be selected from resin including adhesive properties.

With reference to FIG. 1, in some embodiments, a surface function coating layer 18 is further disposed between the surface protection film 19 and the chroma viewing angle enhancement layer 16. The surface function coating layer 18 includes at least one of an anti-glare coating layer, a low reflectance coating layer, and a scratch resistant coating layer.

In some embodiments of the present application, an orthographic projection of an long axis of the light diffusion agent in the first plane has a first orientation angle, and an orthographic projection of an absorption axis of the polarization layer 14 in the first plane has a second orientation angle. The average of the difference between the first orientation angle and the second orientation angle is less than or equal to 5°, and the first plane is parallel to a plane in which the polarization layer is located.

A difference between the first orientation angle and the second orientation angle is an angle difference between the first orientation angle and the second orientation angle. The difference between the first orientation angle and the second orientation angle is an absolute value. The average of the difference between the first orientation angle and the second orientation angle is less than or equal to 5°, and can be 0°, 0.5°, 1°, 1.3°, 1.5°, 1.8°, 2°, 2.3°, 2.5°, 2.8°, 3°, 3.3°, 3.5°, 3.8°, 4°, 4.3°, 4.5°, or 4.8°, which indicates that the average angle difference between the first orientation angle and the second orientation angle ranges from, −5° to 5°. An absolute value of an angle difference between the orthographic projection of the long axis of the light diffusion agent in the first plane and an orthographic projection of the absorption axis of the polarization layer 14 in the first plane being less than or equal to 5° advantages transmission direction of more light changed by the light diffusion agent, which improves the effect of the chroma viewing angle and the contrast.

In some embodiments, an orthographic projection of the long axis of the light diffusion agent in a second plane has a third orientation angle, and an orthographic projection of the absorption axis of the polarization layer 14 in the second plane has a fourth orientation angle. An average of a difference between the third orientation angle and the fourth orientation angle greater than or equal to −5°. The average of the difference between the third orientation angle and the fourth orientation angle is less than or equal to 5°. The second plane is perpendicular to a plane on which the polarization layer 14 is located, the second plane is non-perpendicular to the absorption axis of the polarization layer 14, and the second plane is non-perpendicular to the long axis of the light diffusion agent. An absolute value of an angle difference between the orthographic projection of the long axis of the light diffusion agent in the second plane and orthographic projection of the absorption axis of the polarization layer 14 in the second plane being less than or equal to 5° makes the long axis of the light diffusion agent maintains a state almost parallel to the absorption axis of the polarization layer 14 spatially, and further advantages transmission direction of more light changed by the light diffusion agent, which improves the effect of the chroma viewing angle and the contrast.

In some embodiments, a difference between the third orientation angle and the fourth orientation angle is an angle difference between the third orientation angle and the fourth orientation angle. A difference between the third orientation angle and the fourth orientation angle is an absolute value. The average of the difference between the third orientation angle and the fourth orientation angle is less than or equal to 5°, for example, can be 0°, 0.5°, 1°, 1.3°, 1.5°, 1.8°, 2°, 2.3°, 2.5°, 2.8°, 3°, 3.3°, 3.5°, 3.8°, 4°, 4.3°, 4.5°, or 4.8°, which indicates that an average angle difference between the third orientation angle and the fourth orientation angle ranges from −5° to 5°.

In some embodiments, an average of a difference between the first orientation angle and the second orientation angle is less than or equal to 5°. Namely, when the second orientation angle is 0°, an average of an included angle between the first orientation angle and the second orientation angle is less than or equal to 5°. The average of the difference between the third orientation angle and the fourth orientation angle is less than or equal to 5°. Namely, when the fourth orientation angle is 0°, an average of an included angle between the third orientation angle and the fourth orientation angle is less than or equal to 5°.

The average of the difference in the chroma viewing angle enhancement layer 16 between the first orientation angle and the second orientation angle, the average of the difference between the third orientation angle and the fourth orientation angle can be be obtained by photographing the chroma viewing angle enhancement layer 16 with an optical microscope and then implementing statistical analysis with an existing program.

With reference to FIG. 3, FIG. 3 is a second schematic structural view of a polarizer provided by the embodiment of the present application.

A difference from the first structure of the polarizer as shown in FIG. 1 is that the chroma viewing angle enhancement layer 16 can be manufactured individually a surface of a substrate 17, the surface function coating layer 18 is manufactured on an opposite side of the substrate 17, and then the substrate is attached to the second protection film 15 by an adhesive.

The substrate 17 comprises but is not limited to one of polyethylene terephthalate (PET) thin film, TAC thin film, PC thin film (polycarbonate thin film), poly(methyl methacrylate) thin film (PMMA thin film), and cycloolefin polymer (COP) thin film.

In another embodiment, the chroma viewing angle enhancement layer 16 can be manufactured directly on the second protection film 15 to reduce a thickness of the polarizer 10 and lower the cost. However, it should be noted that the resin composite should be cured by light curing to prevent influence of thermal curing to the polarizer 10.

Furthermore, an adhesive layer 12 is further disposed on a side of the first protection film 13 away from the polarization layer 14, and the adhesive layer 12 comprises but is not limited to pressure sensitive adhesive (PSA). A release film 11 is disposed on a side of the pressure sensitive adhesive away from the polarization layer 14.

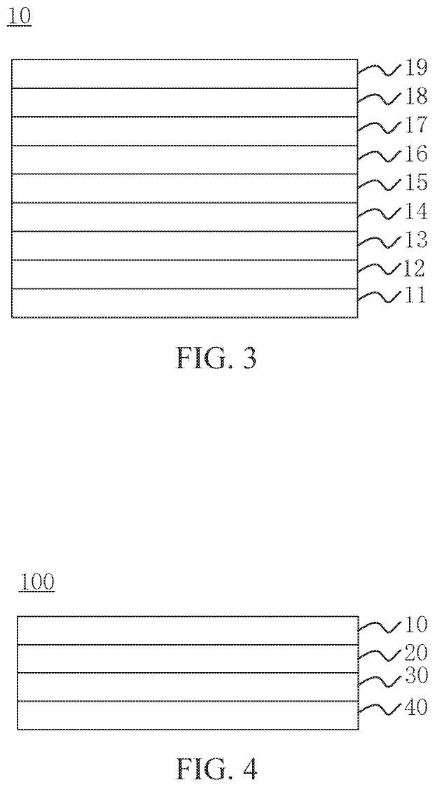

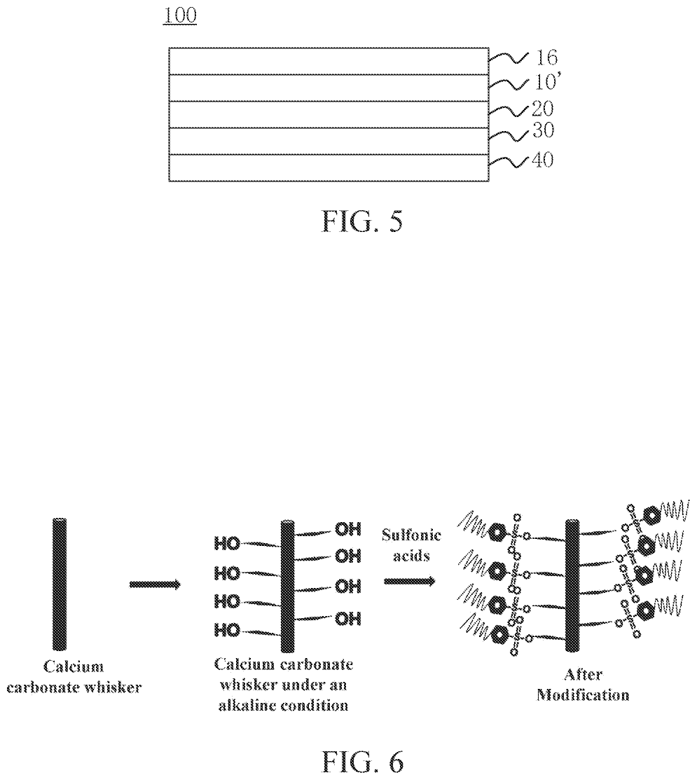

With reference to FIGS. 4 and 5, FIG. 4 is a first schematic structural view of the liquid crystal display device provided by the embodiment of the present application, and FIG. 5 is a second schematic structural view of the liquid crystal display device provided by the embodiment of the present application.

The embodiment of the present application provides a liquid crystal display device, comprising a liquid crystal display panel 20 and a chroma viewing angle enhancement layer 16 located on a light exiting side of the liquid crystal display panel. The chroma viewing angle enhancement layer 16 comprises the resin composite mentioned by the above embodiment. The light diffusion agent of the resin composite is aligned in the chroma viewing angle enhancement layer. The liquid crystal display device provided by the present application can mitigate an issue of color cast of the side viewing angle (large viewing angle), expand the chroma viewing angle of the liquid crystal display device, and would not have negative influence to brightness and contrast of the right viewing angle.

In particular, as shown in FIG. 4, based on the resin composite and the polarizer provided by the above embodiment, the liquid crystal display device provided by the embodiment of the present application comprises a liquid crystal display panel 20, a lower polarizer 30, and an upper polarizer 10. The lower polarizer 30 is located on a side of the liquid crystal display panel 20 (backlight side). The upper polarizer 10 is located on an opposite side to the liquid crystal display panel 20 (light exiting side). The upper polarizer 10 employs a polarizer 10 having a chroma viewing angle enhancement layer 16 in the above embodiment. Compared to a polarizer of the conventional technology, the polarizer 10 provided by the present application can mitigate a color cast issue occurring on the liquid crystal display device at the side viewing angle (large viewing angle) and expand the chroma viewing angle of the liquid crystal display device, and would not have a negative effect to brightness and contrast of the right viewing angle.

The liquid crystal display device further comprises a backlight module 40 disposed on a side of the lower polarizer 30 away from the liquid crystal display panel.

The long axis of the light diffusion agent direction is the same as an extension direction of a short side of the liquid crystal display panel. A short axis direction of the light diffusion agent is the same as an extension direction of a long side 161 of the liquid crystal display panel such that the chroma viewing angle enhancement layer 16 improves the chroma viewing angle along a human eye observation direction.

The liquid crystal display device further comprises a backlight module disposed on a side of the lower polarizer 30 away from the liquid crystal display panel.

In particular, during the polarizer 10 in the above embodiment being bonded to the liquid crystal display panel, the release film 11 is peeled off, and a side with the adhesive layer 12 is bonded to the liquid crystal display panel.

The surface protection film 19 can be peeled off after the polarizer 10 bonded to the liquid crystal display panel, and can be peeled off before subsequent film layer bonding.

With reference to FIG. 5, the chroma viewing angle enhancement layer 16 can be an individual optical film layer disposed on an upper polarizer 10′. Namely, compared to the embodiment in FIG. 4 integrating the chroma viewing angle enhancement layer 16 in the polarizer 10, the present embodiment directly disposes the chroma viewing angle enhancement layer 16 on the conventional upper polarizer 10′, which also has effects of expanding the chroma viewing angle of the liquid crystal display device without having negative influence to brightness and contrast of the right viewing angle.

In particular, the present embodiment provides another liquid crystal display device, comprising a liquid crystal display panel 20, a lower polarizer 30 located on a side of the liquid crystal display panel 20, an the upper polarizer 10′ located on an opposite side of the liquid crystal display panel 20, and a chroma viewing angle enhancement layer 16. The upper polarizer 10′ is located on the light exiting side of the liquid crystal display panel. The chroma viewing angle enhancement layer 16 is disposed on a side of the upper polarizer 10′ away from the liquid crystal display panel. The chroma viewing angle enhancement layer 16 comprises a resin composite. The resin composite comprises acrylic copolymer and a light diffusion agent aligned.

Structures and material of the chroma viewing angle enhancement layer 16 can refer to descriptions of the above-mentioned embodiments and would not be repeatedly described here.

With reference to FIG. 5, the chroma viewing angle enhancement layer 16 in the present embodiment can be manufactured directly on the upper polarizer 10′. It is worth noticing that, during forming a chroma viewing angle enhancement layer 16 by coating the above resin composite on the upper polarizer 10′, the film layer must be cured by light curing to prevent thermal curing from negatively affecting capabilities of the upper polarizer 10′.

In another embodiment, the chroma viewing angle enhancement layer 16 can be manufactured on a individual substrate and then is bonded to the upper polarizer 10′, and an optical adhesive (OCA) can be used for the bonding.

The substrate comprises but is not limited to one of PET thin film, TAC thin film, PC thin film, PMMA thin film, and COP thin film.

The upper polarizer 10′ of the liquid crystal display device of the present embodiment, along a direction away from the liquid crystal display panel, comprises a pressure sensitive adhesive layer, a lower protection film, a PVA layer, an upper protection film, and a surface protection film that are laminated. In some embodiments, a surface function coating layer is further disposed between the upper protection film and the surface protection film. The surface function coating layer comprises at least one of an anti-glare coating layer, a low reflectance coating layer, and a scratch resistant coating layer.

As described above, the polarizer and the liquid crystal display device provided by the present application comprises: a polarization layer; a first protection film located on a side of the polarization layer; a second protection film located on an opposite side of the polarization layer; and a surface protection film located on a side of the second protection film away from the polarization layer, wherein a chroma viewing angle enhancement layer is disposed between the second protection film and the surface protection film, material of the chroma viewing angle enhancement layer comprises a resin composite, the resin composite comprises a light diffusion agent, the light diffusion agent is aligned in the chroma viewing angle enhancement layer, an acute angle is formed between a long axis direction of the light diffusion agent and bottom surface of the chroma viewing angle enhancement layer, and the acute angle is greater than 0° and is less than or equal to 40°. Light diffusion agent aligned in the chroma viewing angle enhancement layer can diffuse light toward two sides to expand a chroma viewing angle of the liquid crystal display device. Also, the chroma viewing angle enhancement layer including the light diffusion agent would not negatively influence brightness of the right viewing angle of the liquid crystal display device.

In the above-mentioned embodiments, the descriptions of the various embodiments are focused. For the details of the embodiments not described, reference may be made to the related descriptions of the another embodiments.

The polarizer and the liquid crystal display device provided by the embodiment of the present application are described in detail as above. The principles and implementations of the present application are described in the following by using specific examples. The description of the above embodiments is only for assisting understanding of the technical solutions of the present application and the core ideas thereof. Those of ordinary skill in the art should understand that they can still modify the technical solutions described in the foregoing embodiments or equivalently replace some of the technical features. These modifications or replacements do not make the essence of the technical solutions depart from a range of the technical solutions of the embodiments of the present application.

1. A polarizer, comprising:
a polarization layer;
a first protection film located on a side of the polarization layer;
a second protection film located on an opposite side of the polarization layer; and
a surface protection film located on a side of the second protection film away from the polarization layer, wherein
a chroma viewing angle enhancement layer is disposed between the second protection film and the surface protection film, material of the chroma viewing angle enhancement layer comprises a resin composite, the resin composite comprises a light diffusion agent, the light diffusion agent is aligned in the chroma viewing angle enhancement layer, an acute angle is formed between a long axis direction of the light diffusion agent and bottom surface of the chroma viewing angle enhancement layer, and the acute angle is greater than 0° and is less than or equal to 40°.

2. The polarizer according to claim 1, wherein the light diffusion agent comprises whiskers and a modified group connected to surfaces of the whiskers, a structure formula of the modified group is —X-A-R, wherein X is selected from SO₃ or PO₄H, A is selected from a substituted or unsubstituted aromatic group in form of a single bond with a number of ring atoms ranging from 6 to 20, or imidazoline group, R is selected from a substituted or unsubstituted alkyl group with a number of carbon atoms of 2-20, a substituted or unsubstituted siloxane group with a number of carbon atoms ranging from 2 to 20, or alkyl alcohol with a number of carbon atoms ranging from 2 to 20 amide group.

3. The polarizer according to claim 2, wherein a structural general formula of R is 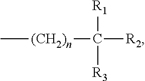
R₁, R₂, R₃ are individually selected from F, Cl, Br, i or H, n is an integer ranging from 1 to 19.

4. The polarizer according to claim 3, wherein R₁, R₂, R₃ are individually selected from F or H, and at least one of R₁, R₂, R₃ is selected from F; and/or
X is selected from SO₃; and/or
A is selected from a substituted or unsubstituted aromatic group with a number of ring atoms ranging from 6 to 20.

5. The polarizer according to claim 2, wherein the modified group is selected from at least one of structure formulas as follows:

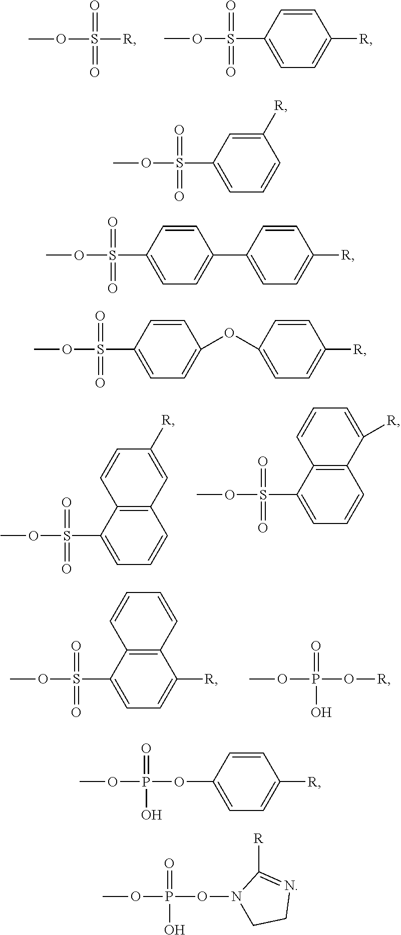

6. The polarizer according to claim 1, wherein an orthographic projection of a long axis of the light diffusion agent in a first plane has a first orientation angle, an orthographic projection of an absorption axis of the polarization layer in the first plane has a second orientation angle, and an average of a difference between the first orientation angle and the second orientation angle is less than or equal to 5°, and the first plane is parallel to a plane in which the polarization layer is located.

7. The polarizer according to claim 1, wherein a film thickness of the chroma viewing angle enhancement layer ranges from 5 to 100 microns.

8. The polarizer according to claim 1, wherein according to a total mass of the resin composite, the resin composite comprises:
acrylate copolymer with a mass percentage ranging from 20% to 80%;
coupling agent with a mass percentage ranging from 0.1% to 10%;
crosslinking agent with a mass percentage ranging from 0.1% to 20%; and
the light diffusion agent with a mass percentage ranging from 0.1% to 50%.

9. The polarizer according to claim 1, wherein an adhesive layer is disposed between the second protection film and the surface protection film, the chroma viewing angle enhancement layer is reused as the adhesive layer.

10. The polarizer according to claim 1, wherein an adhesive layer is disposed between the second protection film and the surface protection film, and the chroma viewing angle enhancement layer is disposed between the adhesive layer and the surface protection film.

11. A liquid crystal display device, comprising a liquid crystal display panel, a polarizer located on a light exiting side of the liquid crystal display panel and comprising:
a polarization layer;
a first protection film located on a side of the polarization layer;
a second protection film located on an opposite side of the polarization layer; and
a surface protection film located on a side of the second protection film away from the polarization layer, wherein
a chroma viewing angle enhancement layer is disposed between the second protection film and the surface protection film, material of the chroma viewing angle enhancement layer comprises a resin composite, the resin composite comprises a light diffusion agent, the light diffusion agent is aligned in the chroma viewing angle enhancement layer, an acute angle is formed between a long axis direction of the light diffusion agent and bottom surface of the chroma viewing angle enhancement layer, and the acute angle is greater than 0° and is less than or equal to 40°.

12. The liquid crystal display device according to claim 11, wherein the light diffusion agent comprises whiskers and a modified group connected to surfaces of the whiskers, a structure formula of the modified group is —X-A-R, wherein X is selected from SO₃ or PO₄H, A is selected from a substituted or unsubstituted aromatic group in form of a single bond with a number of ring atoms ranging from 6 to 20, or imidazoline group, R is selected from a substituted or unsubstituted alkyl group with a number of carbon atoms of 2-20, a substituted or unsubstituted siloxane group with a number of carbon atoms ranging from 2 to 20, or alkyl alcohol with a number of carbon atoms ranging from 2 to 20 amide group.

13. The liquid crystal display device according to claim 12, wherein a structural general formula of R is 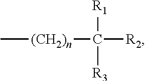
R₁, R₂, R₃ are individually selected from F, Cl, Br, I, or H, and n is an integer ranging from 1 to 19.

14. The liquid crystal display device according to claim 13, wherein R₁, R₂, R₃ are individually selected from F or H, and at least one of R₁, R₂, R₃ is selected from F; and/or
X is selected from SO₃; and/or
A is selected from a substituted or unsubstituted aromatic group with a number of ring atoms ranging from 6 to 20.

15. The liquid crystal display device according to claim 12, wherein the modified group is selected from at least one of structure formulas as follows:

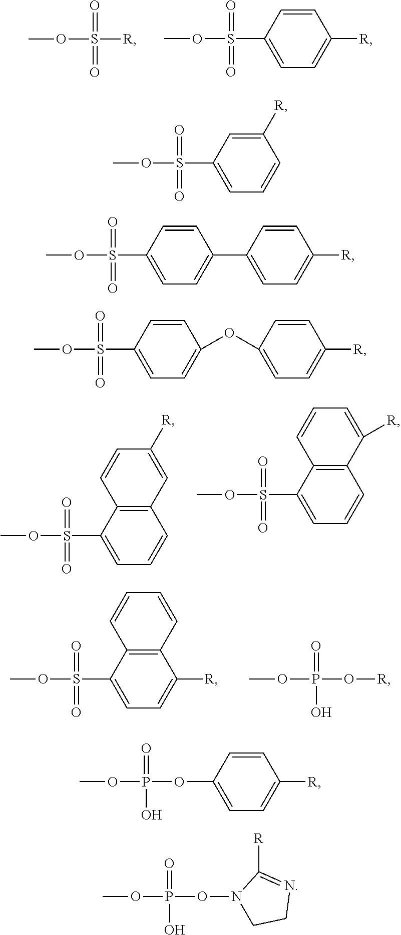

16. The liquid crystal display device according to claim 11, wherein an orthographic projection of a long axis of the light diffusion agent in a first plane has a first orientation angle, an orthographic projection of an absorption axis of the polarization layer in the first plane has a second orientation angle, and an average of a difference between the first orientation angle and the second orientation angle is less than or equal to 5°, and the first plane is parallel to a plane in which the polarization layer is located.

17. The liquid crystal display device according to claim 11, wherein a film thickness of the chroma viewing angle enhancement layer ranges from 5 to 100 microns.

18. The liquid crystal display device according to claim 11, wherein according to a total mass of the resin composite, the resin composite comprises:
acrylate copolymer with a mass percentage ranging from 20% to 80%;
coupling agent with a mass percentage ranging from 0.1% to 10%;
crosslinking agent with a mass percentage ranging from 0.1% to 20%; and
the light diffusion agent with a mass percentage ranging from 0.1% to 50%.

19. The liquid crystal display device according to claim 11, wherein an adhesive layer is disposed between the second protection film and the surface protection film, the chroma viewing angle enhancement layer is reused as the adhesive layer.

20. The liquid crystal display device according to claim 11, wherein an adhesive layer is disposed between the second protection film and the surface protection film, and the chroma viewing angle enhancement layer is disposed between the adhesive layer and the surface protection film.
